(19) United States
(12) Patent Application Publication
(10) Pub. No.: US 2025/0003278 A1
(43) Pub. Date: Jan. 2, 2025

(54) SLIDING-DOOR DRUM ASSEMBLY FOR A VEHICLE

(71) Applicants: HYUNDAI MOTOR COMPANY, Seoul (KR); KIA CORPORATION, Seoul (KR); PYEONG HWA AUTOMOTIVE CO., LTD., Daegu (KR)

(72) Inventors: Hyung-In Yun, Seoul (KR); So-Yeon Park, Seoul (KR); Jong-Han Woo, Hwaseong-si (KR); Ki-Hwan Jeong, Hwaseong-si (KR); Soo-Chul Lee, Suwon-si (KR); Moon-Gyu Choi, Incheon (KR); Seong-Tae Hong, Suwon-si (KR)

(73) Assignees: HYUNDAI MOTOR COMPANY, Seoul (KR); KIA CORPORATION, Seoul (KR); PYEONG HWA AUTOMOTIVE CO., LTD., Daegu (KR)

(21) Appl. No.: 18/504,808

(22) Filed: Nov. 8, 2023

(30) Foreign Application Priority Data
Jun. 30, 2023 (KR) 10-2023-0085081

(51) Int. Cl. E05F 15/643; B60J 5/06

(52) U.S. Cl. CPC E05F 15/643; B60J 5/062; E05Y 2201/654; E05Y 2201/664; E05Y 2900/531

(57) ABSTRACT

A sliding-door drum assembly capable of being assembled in a facilitative manner by enabling a cable to be elastically supported and to maintain an appropriate tensile force after being assembled is proposed. The sliding-door drum assembly includes: a cable pulling a sliding door rotatably installed on a vehicle to slide the sliding door; and a drum around which the cable is wound; a drum adapter connected to an output shaft of a drive unit. The drum is installed on the drum adapter. Additionally, the sliding-door drum assembly may include an elastic member elastically supporting the drum against the drum adapter.

### CROSS-REFERENCE TO RELATED APPLICATION

This application claims priority to and the benefit of Korean Patent Application No. 10-2023-0085081, filed on Jun. 30, 2023, the entire contents of which are incorporated herein by reference.

### BACKGROUND

### Field

The present disclosure relates to a sliding-door drum assembly for a vehicle capable of opening and closing a vehicle sliding door with a cable.

### Description of Related Art

A door through which an occupant gets in and out of a vehicle is installed on a lateral surface of the vehicle.

As illustrated in FIG. 1, a sliding door 2 that slides to open and close is installed on the vehicle 1, such as a van. A rail 1a along which the sliding door 2 slides is installed on a body of the vehicle 1. A roller (not shown) that runs along the rail 1a is installed on the sliding door 2. A door lock for locking the sliding door 2 when the sliding door 2 is closed is provided on the sliding door 2.

In recent years, more vehicles have implemented power sliding doors that open and close using a drive power of a drive motor to improve passenger convenience.

A drive unit 10 is installed inside the sliding door 2. The drive unit 10 includes a drive motor 11, first and second cables 12 and 13, first and second pulley units 14 and 15, and the like. The first and second cables 12 and 13 are wound around or unwound from a drum (not shown) and push or pull the sliding door 2. The first and second pulley units 14 and 15 include respective pulleys (not shown) to switch winding directions of the first and second cables 12 and 13. The drive unit 10 is connected to the drum. The drive unit 10 rotates the drum around which the first cable 12 and the second cable 13 are wound, such as to pull the first cable 12 or the second cable 13, respectively. Thus, the sliding door 2 slidingly moves toward a front or rear direction of the vehicle 1, thereby being opened or closed.

One end portion of the first cable 12 and one end portion of the second cable 13 are respectively fixed on the drum around which the first cable 12 and the second cable 13 are to be wound. The other end portion of the first cable 12 and the other end portion of the second cable 13 each is connected to a roller arm 2a fastened to one side of the sliding door 2. The rail 1a is installed on the vehicle 1 in the front or rear direction of the vehicle 1, and the roller that runs on the rail 1a is installed on the roller arm 2a. When the drive motor rotates the drum, the first cable 12 and the second cable 13 pull the roller arm 2a toward the front or rear direction of the vehicle 1 along with rotation of the drum, thereby sliding the sliding door 2.

When the first cable 12 and the second cable 13 are connected to the roller arm 2a, the first cable 12 and the second cable 13 have to be tightly pulled in a state of tension for the connection to the roller arm 2a. However, the first cable 12 and the second cable 13 are not easily connected to the roller arm 2a because the first cable 12 and the second cable 13 have no elasticity.

### SUMMARY

Embodiments of the present disclosure provide a sliding-door drum assembly for a vehicle, which is capable of pulling a cable to a predetermined length in order to fix an end portion of the cable to a drum during assembling. Another embodiment of the present disclosure is to provide elasticity to the cable to maintain an appropriate tensile force after assembling.

In an embodiment of the present disclosure, there is provided a sliding-door drum assembly for a vehicle. The sliding-door drum assembly includes: a cable configured to pull a sliding door slidably installed on a vehicle to slide the sliding door; a drum around which the cable is wound; and a drum adapter connected to an output shaft of a drive unit. The drum is installed on the drum adapter. In an embodiment, the sliding-door drum assembly includes an elastic member elastically supporting the drum against the drum adapter.

In another embodiment, the cable may include: a first cable pulling the sliding door toward a first direction of the vehicle; and a second cable pulling the sliding door toward a second direction of the vehicle. The drum may include: an upper drum around which the first cable or the second cable is wound; and a lower drum around which an other of the first cable or the second cable is wound. The lower drum is coaxially installed below the upper drum.

In the sliding-door drum assembly, one end portion of the first cable may be fixed on the upper drum, and the first cable may be wound to a predetermined length. Additionally, in the sliding-door assembly, one end portion of the second cable may be fixed on the lower drum, and the second cable may be wound to a predetermined length.

In the sliding-door drum assembly, the drum adapter may be positioned between the upper drum and the lower drum. The upper drum may be installed over the drum adapter, and the lower drum may be installed under the drum adapter.

In the sliding-door drum assembly, the elastic member may include an upper spring. The opposite ends of the upper spring may be fixed on the upper drum and the drum adapter, respectively. The elastic member may also include a lower spring. The opposite ends of the lower spring may be fixed on the lower drum and the drum adapter, respectively.

In the sliding-door drum assembly, a spring accommodation portion may be formed in the drum adapter in a radial direction of the drum adapter to accommodate one end portion of the upper spring or one end portion of the lower spring. The spring accommodation portion may face from a circumference of the drum adapter toward the center of the drum adapter.

In the sliding-door drum assembly, the one end portion of the upper spring and the one end portion of the lower spring may be formed to be bent facing toward the center of the drum adapter.

In the sliding-door drum assembly, a reinforcing rib may be formed on the drum adapter that protrudes along a circumferential direction and the radial direction of the drum adapter. The spring accommodation portion may be formed in the radial direction of the drum adapter that passes through the reinforcing rib formed in a circumferential direction of the drum adapter.

In the sliding-door drum assembly, an upper coupling protrusion that is inserted into a bottom surface of the upper drum may be formed on the drum adapter. Additionally, an upper stopper that blocks the upper coupling protrusion when the upper drum rotates by a first predetermined angle with respect to the drum adapter may be formed on the inside of the upper drum.

In the sliding-door drum assembly, a lower coupling protrusion that is inserted into an upper surface of the lower drum may be formed on the drum adapter. A lower stopper that blocks the lower coupling protrusion when the lower drum rotates by a second predetermined angle with respect to the drum adapter may be formed on the inside of the lower drum.

In the sliding-door drum assembly, another end portion of the first or second cable may be connected to a roller arm installed on one side of the sliding door.

In the sliding-door drum assembly, when the drum rotates in a state of being electrically supported by pulling the one end portion of the first or second cable, the other end portion of the first or second cable may be connected to the roller arm.

In the sliding-door drum assembly, an inner surface of the drum adapter may be spline-machined to form a spline portion.

The sliding-door drum assembly according to the present disclosure is configured as described above, and the end portion of the first or second cable may be pulled elastically to a predetermined length during the assembly of the sliding door. This may facilitate the process of fixing the end portion of the first or second cable to the upper or lower drum.

Moreover, in a state where the assembling of the cable is completed, with the spring, the first or second cable may maintain a tensile force to an appropriate level, which helps easy and smooth the opening or closing operation of the sliding door.

### BRIEF DESCRIPTION OF THE DRAWINGS

These drawings are for reference only in describing embodiments of the present disclosure. Therefore, the technical idea of the present disclosure should not be limited to the accompanying drawings.

FIG. 1 is a side view illustrating a state where a typical sliding door is installed in the related art.

FIG. 2 is a schematic view illustrating a configuration where a drive unit opening and closing the sliding door is installed inside the typical sliding door in the related art.

FIG. 3 is a perspective view illustrating a state where a cable is fixed in the typical sliding door in the related art.

FIG. 4 is an exploded perspective view illustrating a sliding-door drum assembly for a vehicle according to the present disclosure.

FIG. 5 is a top view illustrating an upper drum when a first cable wound around the upper drum is pulled in a sliding-door drum assembly for a vehicle according to the present disclosure.

FIG. 6 is a top view illustrating the upper drum where the first cable is completely installed in the sliding-door drum assembly for a vehicle according to the present disclosure.

FIG. 7 is a top view illustrating a drum adapter of the sliding-door drum assembly for a vehicle according to the present disclosure.

FIG. 8 is a perspective view illustrating the upper drum and a lower drum in a state where the sliding-door drum assembly for a vehicle is normally assembled.

FIG. 9 is a cross-sectional view illustrating a state where the drum adapter and the upper drum are coupled to each other in the sliding-door drum assembly for a vehicle according to the present disclosure.

FIG. 10 is a cross-section view illustrating a state where the drum adapter and the lower drum are coupled to each other in the sliding-door drum assembly for a vehicle according to the present disclosure.

FIG. 11 is a plan view illustrating the drum adapter in a state where the cable is normally assembled to the drum adapter in the sliding-door drum assembly for a vehicle according to the present disclosure.

FIG. 12 is a perspective view illustrating the upper drum and the lower drum in a state where the sliding-door drum assembly for a vehicle according to the present disclosure is abnormally assembled.

FIG. 13 is a plan view illustrating the drum adapter in the state where the sliding-door drum assembly for a vehicle according to the present disclosure is abnormally assembled.

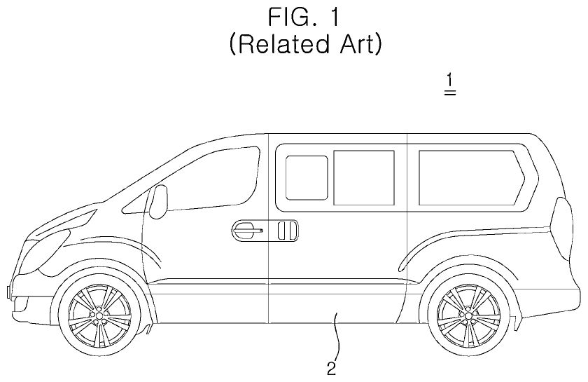

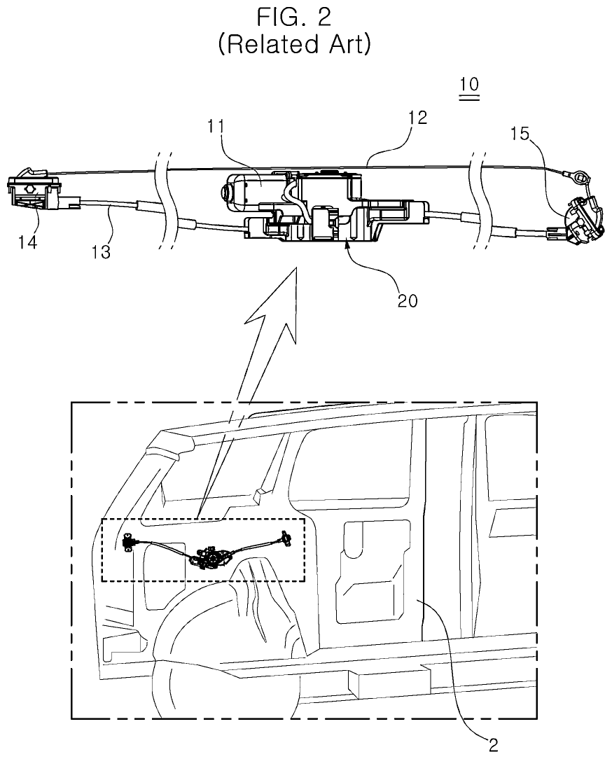

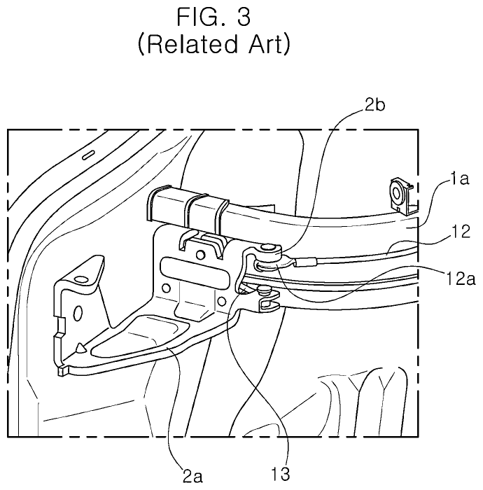

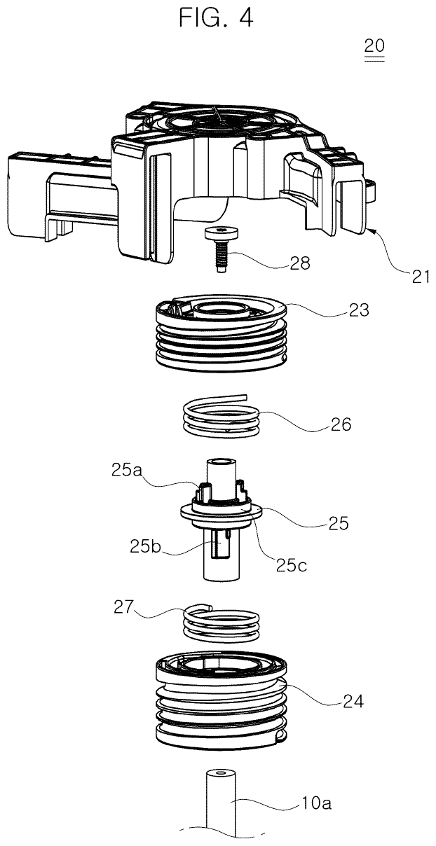

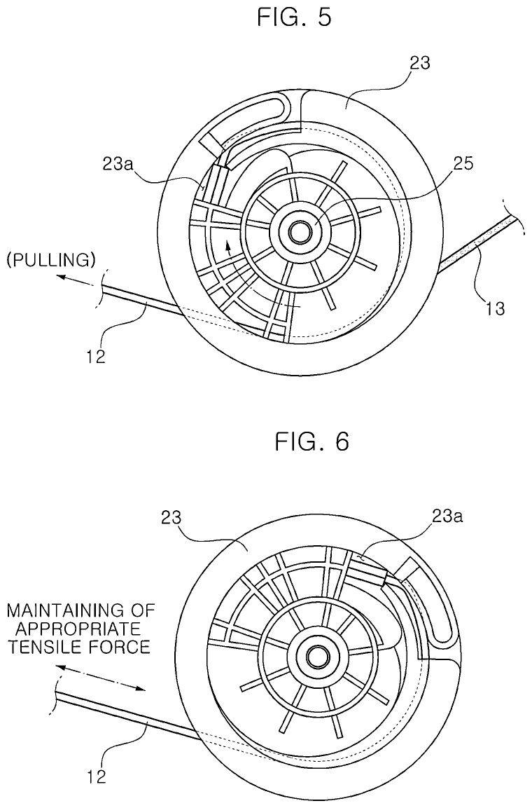

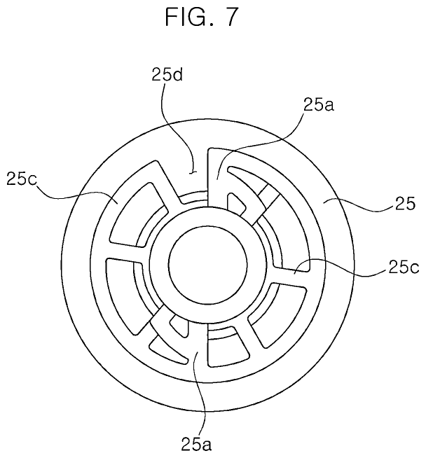

### DETAILED DESCRIPTION

A sliding-door drum assembly 20 for a vehicle according to the present disclosure is described in detail below with reference to the accompanying drawings.

When one component is referred to as being “connected” or “joined” to another component, the one component may be directly connected or joined to the other component, but it should be understood that other components may be present therebetween. On the other hand, when the one component is referred to as being “directly connected to” or “directly in contact with” the other component, it should be understood that other components are not present therebetween. Other expressions for describing relationships between components, such as, “between” and “directly between” or “adjacent to” and “directly adjacent to”, should be interpreted in the same manner.

When a component, device, element, or the like of the present disclosure is described as having a purpose or performing an operation, function, or the like, the component, device, or element should be considered herein as being “configured to” meet that purpose or perform that operation or function.

The sliding-door drum assembly 20 according to the present disclosure may include cables 12 and 13, drums 23 and 24, a drum adapter 25, and elastic members 26 and 27. The cables 12 and 13 slide a sliding door 2, which is slidably installed on a vehicle 1, by pulling the sliding door 2. The cables 12 and 13 are wound around the drums 23 and 24, respectively. The drum adapter 25 may be connected to an output shaft 10a of a drive unit 10. The drums 23 and 24 are installed on the drum adapter 25. The elastic members 26 and 27 elastically support the drums 23 and 24 against the drum adapter 25.

The cables 12 and 13 may be installed in a state of being wound around the drum assembly 20 and move the sliding door 2, which is slidably installed on the vehicle 1, toward the front or rear of the vehicle 1.

A rail 1a may be installed on one side of the vehicle 1 in the forward-backward direction of the vehicle 1. A roller arm 2a may be installed on one side of the sliding door 2. A roller (not illustrated) may slide along the rail 1a. When the cables 12 and 13 pull the roller arm 2a toward the forward or backward direction, the sliding door 2 may slide toward a direction in which the cables 12 and 13 pull the sliding door 2.

The cables 12 and 13 may correspond to a first cable 12 and a second cable 13, respectively. The first cable 12 may pull the roller arm 2a toward the front or rear of the vehicle 1. The second cable 13 may pull the roller arm 2a toward the opposite direction.

The drums 23 and 24 may be rotatably installed inside a housing 21. The cables 12 and 13 may be wound around the drums 23 and 24, respectively. Winding the cables 12 and 13 enables the cables 12 and 13 to pull the sliding door 2. The drums 23 and 24 may have the same structure, preferably, a symmetrical configuration and may correspond to an upper drum 23 and a lower drum 24, respectively. The first cable 12 may be wound around the upper drum 23, and the second cable 13 may be wound around the lower drum 24.

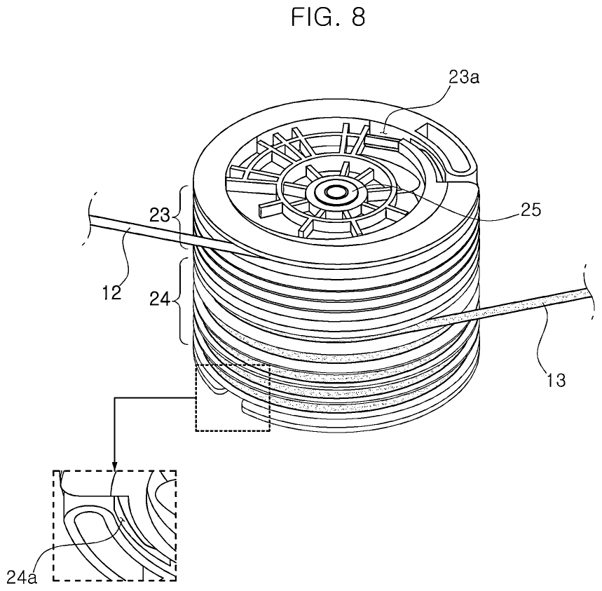

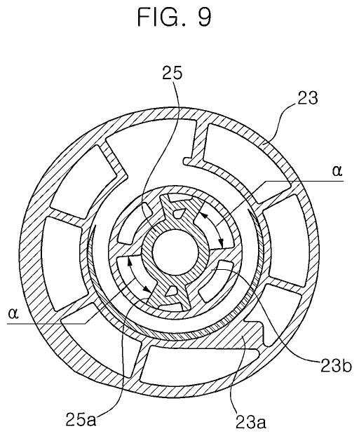

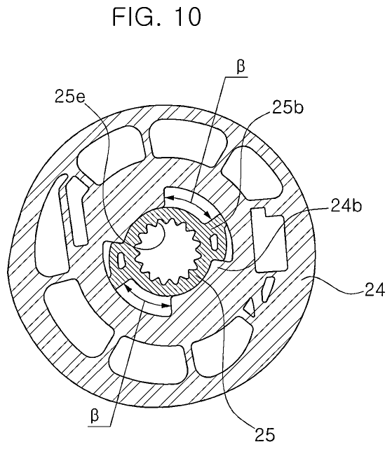

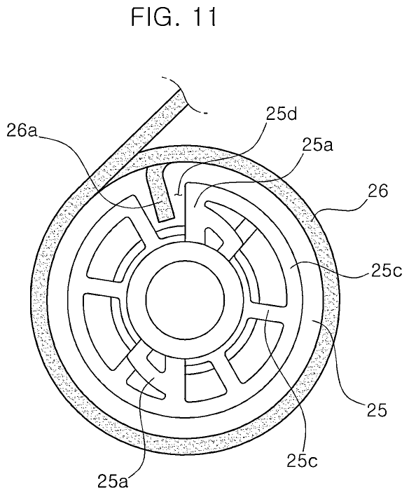

End portions of the first cable 12 and the second cable 13 may be fixed on the upper drum 23 and the lower drum 24, respectively. The first cable 12 and the second cable 13 may be wound to a predetermined length around the upper drum 23 and the lower drum 24, respectively. For example, as shown in FIG. 8, an end portion of the first cable 12 may be fixed on a cable fixation portion 23a formed on the upper drum 23. Similarly, an end portion of the second cable 13 may be fixed on a cable fixation portion (24a) formed on the lower drum 24. The first cable 12 and the second cable 13 may be wound around the upper drum 23 and the lower drum 24, respectively, toward opposite directions.

Winding the first cable 12 around the upper drum 23 may allow the first cable 12 to pull the sliding door 2, enabling the sliding door 2 to move toward the front or rear of the vehicle 1. Winding the second cable 13 around the lower drum 24 may allow the second cable 13 to pull the sliding door 2, enabling the sliding door 2 to slide toward the opposite direction.

The drum adapter 25 may be installed between the upper drum 23 and the lower drum 24. The upper drum 23 may be arranged over the lower drum 24 in the upward-downward direction. An upper portion of the drum adapter 25 may be connected to the upper drum 23, and a lower portion of the drum adapter 25 may be connected to the lower drum 24. The drum adapter 25 may be formed to have the same shape as a disk through which a pipe passes. The upper drum 23 may be installed over the drum adapter 25, and the lower drum 24 may be installed under the drum adapter 25.

In addition, an upper coupling protrusion 25a and a lower coupling protrusion 25b that are coupled to the upper drum 23 and the lower drum 24, respectively, may be formed on the drum adapter 25.

The upper coupling protrusion 25a may be inserted into a bottom surface of the upper drum 23. Inside the upper drum 23, a space may be formed in a manner that allows for the insertion of the upper coupling protrusion 25a. This space also may facilitate the rotation of the coupling protrusion 25a by a predetermined angle (α). An upper stopper 23b may be formed on an inner surface of the upper drum 23. The upper stopper 23b may restrict the rotation of the upper drum 23 when the upper drum 23 rotates by the predetermined angle (α) with respect to the drum adapter 25. Accordingly, the upper drum 23 may rotate by the predetermined angle (α) with respect to the drum adapter 25.

Likewise, a lower stopper 24b may be formed on the lower drum 24. The lower stopper 24b may restrict rotation of the lower drum 24 when the lower coupling protrusion 25b is also inserted into the lower drum 24 and the lower drum 24 may rotate by a predetermined angle (β) with respect to the drum adapter 25. The lower drum 24 may also rotate by a predetermined angle (β) with respect to the drum adapter 25.

A reinforcing rib 25c may be formed on the drum adapter 25. The reinforcing rib 25c may increase the rigidity of a middle disk portion of the drum adapter 25 in the circumferential and radial directions.

The drum adapter 25 may be fixed on the output shaft 10a of the drive unit 10. With the drum adapter 25, when the drive unit 10 operates, winding the first cable 12 around the upper drum 23 along a rotational direction of the output shaft 10a may allow the first cable 12 to pull the sliding door 2, enabling the sliding door 2 to slide toward one direction. Alternatively, winding the second cable 13 around the lower drum 24 may allow the second cable 13 to pull the sliding door 2, enabling the sliding door 2 to slide toward the opposite direction.

The drum adapter 25 may be connected to the output shaft 10a of the drive unit 10, thereby transferring the drive power of the drive unit 10 to the drum assembly 20. In a state where the output shaft 10a passes through the drum adapter 25, an upper end portion of the drum adapter 25 and the output shaft 10a may be fastened to each other for assembling, using a tapping bolt 28. At this point, one portion of an inner surface of the drum adapter 25 may be spline-machined in such a manner as to form a spline portion 25e. Additionally, one portion of an outer surface of the output shaft 10a may be also spline-machined (not illustrated), thereby preventing a slippage from occurring between the drum adapter 25 and the output shaft 10a.

The elastic members 26 and 27 may be installed between the drum adapter 25 and the upper drum 23 and between the drum adapter 25 and the lower drum 24, respectively, in such a manner as to support the upper drum 23 and the lower drum 24, respectively, against the drum adapter 25.

The elastic members 26 and 27 may correspond to an upper spring 26 and a lower spring 27, respectively. The upper spring 26 may be installed between the drum adapter 25 and the upper drum 23, and the lower spring 27 may be installed between the drum adapter 25 and the lower drum 24. The upper spring 26 and the lower spring 27 each may be formed in the form of a coil spring.

The upper spring 26 elastically may support the upper drum 23 against the drum adapter 25 in the rotational direction of the drum 23. When the first cable 12 is connected to the roller arm 2a, the first cable 12 may be pulled to a predetermined length, facilitating a connection of the first cable 12 to the roller arm 2a. In a case where the first cable 12 is connected to the roller arm 2a, the first cable 12 may maintain an appropriate tensile force.

Likewise, the lower spring 27 may also elastically support the lower drum 24 in a rotational direction against the drum adapter 25. The lower spring 27 may also facilitate a connection between the second cable 13 and the roller arm 2a, while enabling the second cable 13 to maintain an appropriate tensile force.

The upper spring 26 and the lower spring 27 may elastically support the upper drum 23 and the lower drum 24, respectively, against the drum adapter 25. Because of this, when the first cable 12 and the second cable 13 are connected to the roller arm 2a, pulling the first cable 12 and the second cable 13 may enable the first cable 12 and the second cable 13 to move to predetermined lengths, facilitating connections of the first cable 12 and the second cable 13 to the roller arm 2a. For example, when the first cable 12 is pulled, a connection ring 12a installed on an end portion of the first cable 12 may be connected to a cable connection portion 2b of the roller arm 2a. Thus, the first cable 12 may be connected to the roller arm 2a.

The first cable 12 and the second cable 13 may be connected to the roller arm 2a. Thereafter, with the upper spring 26 and the lower spring 27, the first cable 12 and the second cable 13, respectively, may maintain an appropriate tensile force.

Both end portions of the upper spring 26 may be fixed on the drum adapter 25 and the upper drum 23, respectively. Particularly, a spring accommodation portion 25d may be formed in the drum adapter 25. One end portion of the upper spring 26 may be seated in the spring accommodation portion 25d. The spring accommodation portion 25d may be formed in the drum adapter 25 by recessing a circumference of the drum adapter 25 in the radiation direction thereof. The reinforcing rib 25c may not be formed in a portion of the drum adapter 25 in which the spring accommodation portion 25d is to be formed. Instead, the spring accommodation portion 25d may be formed in the portion thereof in such a manner as to accommodate one end portion of the upper spring 26. In other word, the spring accommodation portion 25d may be formed in the radial direction of drum adapter 25 in a manner that passes through the reinforcing rib 25c formed in the circumferential direction of the drum adapter 25. The spring accommodation portion 25d may be formed in such a manner as to have the same height as the reinforcing rib 25c and to face from the circumference of the drum adapter 25 toward the center of the drum adapter 25, so that one end portion of the upper spring 26 is accommodated into the spring accommodation portion 25d. Particularly, the upper spring 26 itself may serve to guide a position at which the upper spring 26 is installed. When the upper drum 23 and the upper spring 26 are assembled, a coupling portion 26a, which is bent from one end portion of the upper spring 26 in a manner that faces toward the center of the drum adapter 25, may be positioned at the spring accommodation portion 25d. Only with this position of the coupling portion 26a, the upper drum 23 and the upper spring 26 may be assembled at respective regular positions with respect to the drum adapter 25.

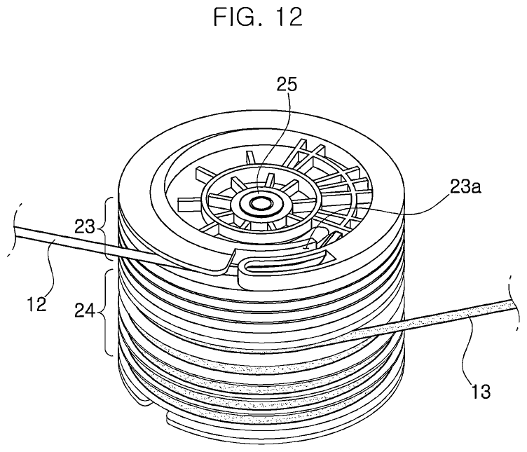

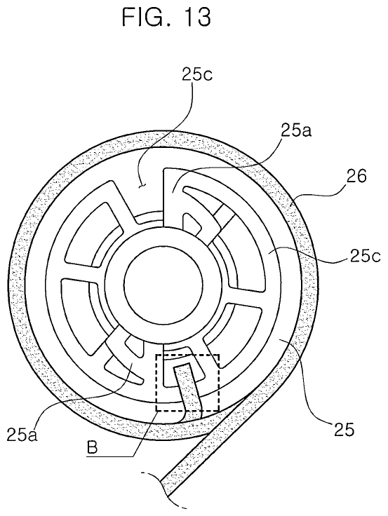

FIGS. 8 and 11 illustrate that one end portion of the upper spring 26 is assembled at its regular position in the spring accommodation portion 25d. FIGS. 12 and 13 illustrate that the one end portion of the upper spring 26 is not positioned at its regular position in the spring accommodation portion 25d. Non-positioning of the one end portion of the upper spring 26 in the spring accommodation portion 25d may facilitate recognition of whether or not erroneous assembling occurs. When the upper drum 23 and the upper spring 26 are not assembled at their respective regular positions, as a result, the first cable 12 may be longer or shorter than when in a normal state. When the first cable 12 is unwound to a longer length, even when the first cable 12 is connected to the roller arm 2a, the first cable 12 may be too long to maintain an appropriate tensile force. When the first cable 12 is unwound to a shorter length, the first cable 12 cannot be connected to the roller arm 2a.

However, when one end portion of the upper spring 26 is positioned in the spring accommodation portion 25d, the upper drum 23 and the upper spring 26 may be positioned at their respective regular positions. This positioning may enable the first cable 12 to be unwound to an intended length. Accordingly, the connection of the first cable 12 to the roller arm 2a may be facilitated. Furthermore, after being connected to the roller arm 2a, the first cable 12 may be enabled to maintain an appropriate tensile force.

The spring accommodation portion 25d may be also formed in a bottom surface of the disk portion of the drum adapter 25. As a result, the lower drum 24 and the lower spring 27 may be enabled to be assembled at their respective positions.

What is claimed is:

1. A sliding-door drum assembly for a vehicle comprising:
at least one cable configured to pull a sliding door slidably installed on a vehicle to slide the sliding door;
a drum around which the at least one cable is wound;
a drum adapter connected to an output shaft of a drive unit, wherein the drum is installed on the drum adapter; and
an elastic member configured to elastically support the drum against the drum adapter.

2. The sliding-door drum assembly of claim 1, wherein the at least one cable comprises:
a first cable configured to pull the sliding door toward a first direction of the vehicle; and
a second cable configured to pull the sliding door toward a second direction of the vehicle, and
wherein the drum comprises:
an upper drum around which one cable, among the first cable and the second cable, is wound; and
a lower drum around which the other cable, among the first cable and the second cable, is wound, the lower drum being coaxially installed below the upper drum.

3. The sliding-door drum assembly of claim 2, wherein one end portion of the first cable is fixed on the upper drum, and the first cable is wound to a predetermined length, and
wherein one end portion of the second cable is fixed on the lower drum, and the second cable is wound to a predetermined length.

4. The sliding-door drum assembly of claim 2, wherein the drum adapter is positioned between the upper drum and the lower drum, and
wherein the upper drum is installed over the drum adapter, and the lower drum is installed under the drum adapter.

5. The sliding-door drum assembly of claim 4, wherein the elastic member comprises:
an upper spring, opposite ends of the upper spring being fixed on the upper drum and the drum adapter, respectively; and
a lower spring, opposite ends of the lower spring being fixed on the lower drum and the drum adapter, respectively.

6. The sliding-door drum assembly of claim 5, wherein a spring accommodation portion is formed in the drum adapter in a radial direction of the drum adapter to accommodate one end portion of the upper spring or one end portion of the lower spring, and
wherein the spring accommodation portion is formed to face from a circumference of the drum adapter toward a center of the drum adapter.

7. The sliding-door drum assembly of claim 6, wherein the one end portion of the upper spring and the one end portion of the lower spring are formed to be bent facing toward the center of the drum adapter.

8. The sliding-door drum assembly of claim 6, wherein a reinforcing rib is formed on the drum adapter that protrudes along a circumferential direction and the radial direction of the drum adapter, and
wherein the spring accommodation portion is formed in the radial direction of the drum adapter that passes through the reinforcing rib formed in a circumferential direction of the drum adapter.

9. The sliding-door drum assembly of claim 6, wherein an upper coupling protrusion that is inserted into a bottom surface of the upper drum is formed on the drum adapter, and
wherein an upper stopper is formed on an inside of the upper drum and configured to block the upper coupling protrusion when the upper drum rotates by a first predetermined angle with respect to the drum adapter.

10. The sliding-door drum assembly of claim 6, wherein a lower coupling protrusion is formed on the drum adapter and configured to insert into an upper surface of the lower drum, and
wherein a lower stopper is formed on an inside of the lower drum and configured to block the lower coupling protrusion when the lower drum rotates by a second predetermined angle with respect to the drum adapter.

11. The sliding-door drum assembly of claim 3, wherein another end portion of the first or second cable is connected to a roller arm installed on one side of the sliding door.

12. The sliding-door drum assembly of claim 11, wherein when the drum rotates in a state of being electrically supported by pulling the one end portion of the first or second cable, the other end portion of the first or second cable is connected to the roller arm.

13. The sliding-door drum assembly of claim 1, wherein an inner surface of the drum adapter is spline-machined to form a spline portion.

14. A sliding-door drum assembly for a vehicle comprising:
a first cable and a second cable respectively configured to pull a sliding door slidably installed on a vehicle;
a drum including an upper drum and a lower drum being coaxially installed below the upper drum, wherein the first cable is wound around the upper drum and the second cable is wound around the lower drum;
a drum adapter connected to an output shaft of a drive unit and positioned between the upper drum and the lower drum; and
an elastic member configured to elastically support the upper drum and the lower drum against the drum adapter.

15. The sliding-door drum assembly of claim 14, wherein the first cable is configured to pull the sliding door toward a first direction of the vehicle; and
the second cable is configured to pull the sliding door toward a second direction of the vehicle.

16. The sliding-door drum assembly of claim 15, wherein the first cable is wound to a first predetermined length, and the second cable is wound to a second predetermined length.

17. The sliding-door drum assembly of claim 14, wherein the elastic member comprises:
an upper spring including a first end portion fixed to the upper drum and a second end portion fixed to the drum adapter; and
a lower spring including a first end portion fixed to the lower drum and a second end portion fixed to the drum adapter.

18. The sliding-door drum assembly of claim 17, wherein a spring accommodation portion is formed in the drum adapter to accommodate the second end portion of the upper spring or the second end portion of the lower spring.

19. The sliding-door drum assembly of claim 18, wherein the spring accommodation portion is formed in a radial direction of the drum adapter to face from a circumference of the drum adapter toward a center of the drum adapter.

20. The sliding-door drum assembly of claim 17, wherein the second end portion of the upper spring and the second end portion of the lower spring are formed to be bent facing toward a center of the drum adapter.
